(19) United States
(12) Patent Application Publication
(10) Pub. No.: US 2012/0125142 A1
(43) Pub. Date: May 24, 2012

(54) ACCELERATOR PEDAL FOR VEHICLE

(75) Inventors: Eunsik Kim, Daegu (KR); Yangrae Cho, Hwaseong-si (KR); Jongsang Noh, Ulsan (KR); Jonggeun Cha, Ulsan (KR)

(73) Assignees: Hyundai Motor Company, Seoul (KR); Donghee Industrial Co., Ltd., Ulsan Metropolitan City (KR); Kia Motors Corporation, Seoul (KR)

(21) Appl. No.: 13/190,772

(22) Filed: Jul. 26, 2011

(30) Foreign Application Priority Data
Nov. 18, 2010 (KR) 10-2010-0114873

(51) Int. Cl. G05G 1/445

(52) U.S. Cl. 74/513

(57) ABSTRACT

An acceleration pedal for a vehicle includes a pedal arm where a pedal is connected and that is rotatably mounted; a straight actuator that presses pedal arm in a return direction by moving straight; and a controller that controls straight actuator. Therefore, according to the acceleration pedal for a vehicle, it is possible to not only generate mechanical or electric signals to transmit driver's intention of acceleration to a power generator, but allow the driver to safely and economically drive and send specific signals to the driver by applying active action to the acceleration pedal.

### CROSS-REFERENCE TO RELATED APPLICATIONS

The present application claims priority to Korean Patent Application Number 10-2010-0114873 filed Nov. 18, 2010, the entire contents of which application is incorporated herein for all purposes by this reference.

### BACKGROUND OF INVENTION

1. Field of Invention

The present invention relates to an acceleration pedal for a vehicle, and more particularly, to an acceleration pedal for a vehicle which can restrict a driver to operate the acceleration pedal or send an active signal to the driver.

2. Description of Related Art

In the related art, acceleration pedals of vehicles are merely simple mechanical parts that only generate signals for controlling the operation of power generators, such as the engine in the vehicles, using the operational force from the drivers.

However, with various requirements for vehicles in recent years, acceleration pedals provided with additional functions, such as allowing drivers to more economically drive vehicles and inducing the drivers to safely drive have increased in use.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an acceleration pedal for a vehicle that cannot only generate mechanical or electric signals to transmit driver's intention of acceleration to a power generator, but allow the driver to safely and economically drive and send specific signals to the driver by applying active action to the acceleration pedal.

Various aspects of the present invention provide an acceleration pedal for a vehicle, including a pedal arm where a pedal is connected and that is rotatably mounted, a straight actuator that presses the pedal arm in a return direction by moving straight, and a controller that controls the straight actuator.

According to various embodiments of the present invention, it is possible to not only generate mechanical or electric signals to transmit driver's intention of acceleration to a power generator, but allow the driver to safely and economically drive and send specific signals to the driver by applying active action to the acceleration pedal.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing the configuration of an exemplary acceleration pedal for a vehicle according to the present invention.

FIG. 2 is an exploded perspective view of main parts shown in FIG. 1.

FIG. 3 is a view showing in detail a rod return mechanism shown in FIG. 2.

FIG. 4 is a view comparing the operation of the present invention.

FIGS. 5 to 9 are graphs illustrating examples of operations that can be implemented by the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the inventions) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

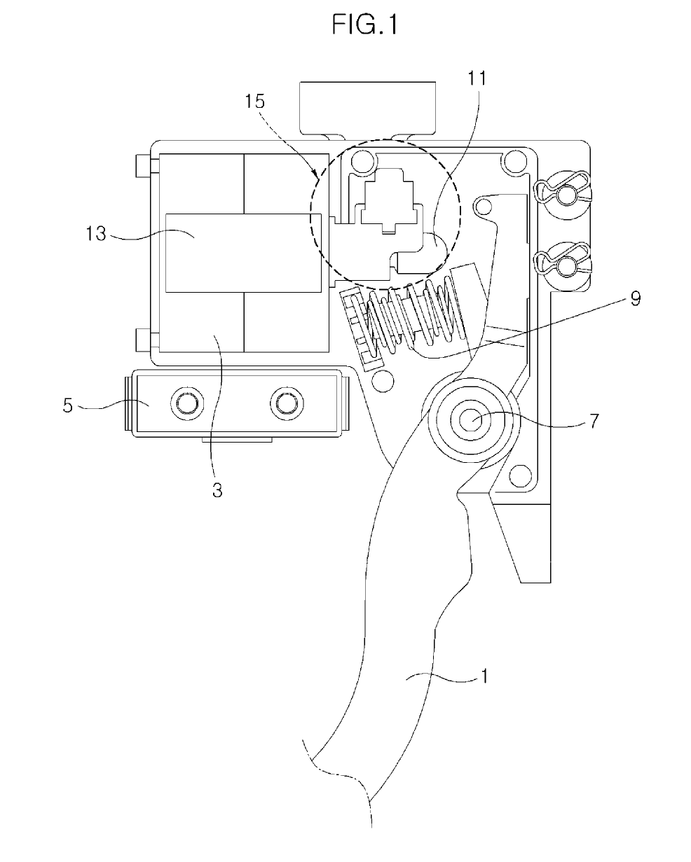

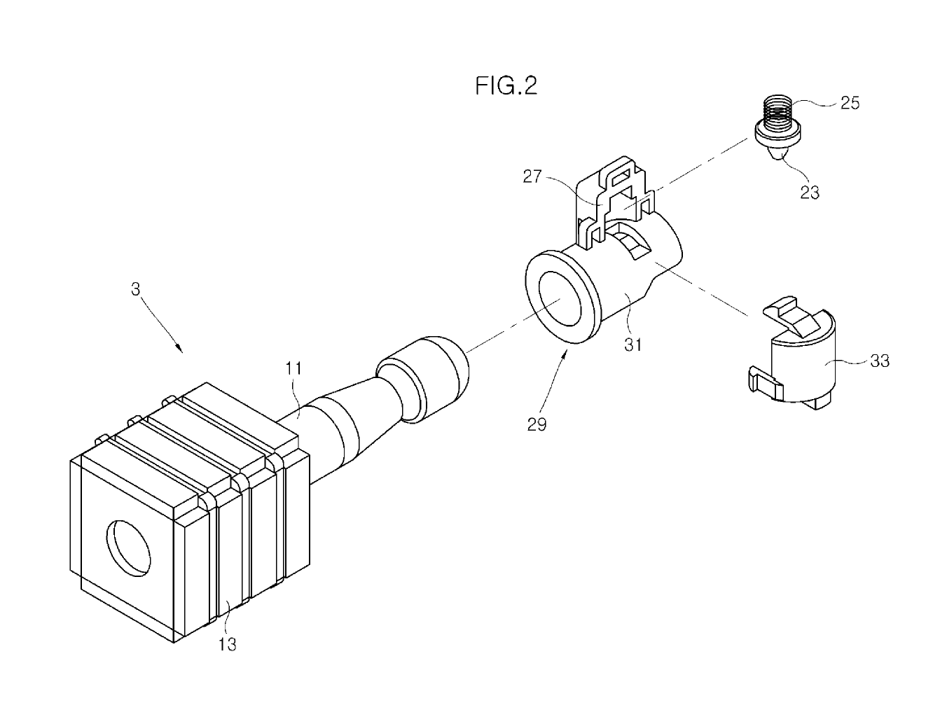

Referring to FIGS. 1 to 4, an acceleration pedal according to various embodiments of the present invention includes a pedal arm where a pedal is connected and that is rotatably mounted, a straight actuator 3 that can press pedal arm 1 in a return direction by moving straight, and a controller 5 that controls straight actuator 3.

That is, controller 5 operates straight actuator 3 in accordance with various conditions, such that operational force is applied to pedal arm 1.

Obviously, controller 5 controls straight actuator 3 in accordance with a predetermined logic by receiving signals from a specific operational switch by a driver or signals from various sensors for checking the operational conditions of the vehicle.

Pedal arm 1 is rotated about a hinge shaft 7, when the driver presses down the pedal, in which assume that this is an operational direction and the direction in which the pedal arm is returned by a return spring 9 when the driver releases the pedal is the return direction.

Straight actuator 3 includes a power transmission rod 11 that can longitudinally move straight toward pedal arm 1, an electromagnetic driver 13 that moves straight power transmission rod 11, and a rod return mechanism 15 that returns power transmission rod 11 to a predetermined position.

Electromagnetic driver 13 includes all devices that can allows power transmission rod 11 to move straight, using electromagnetic force generated by a coil, and may be a one-way solenoid device that allows power transmission rod 11 to move straight only in one direction toward pedal arm 1, or a two-way solenoid device or a linear motor that can allow power transmission rod 11 to move straight toward and away from pedal arm 1.

The one-way solenoid device has a relatively simple configuration and operates with rod return mechanism 15 (described below), such that the control logic of controller 5 can be simply implemented.

Power transmission rod 11 is spaced apart from pedal arm 1 when returned by rod return mechanism 15, a shock-absorbing member 17 is disposed at pedal arm 1 that the front end of power transmission rod 11 contacts, and the front end of power transmission rod 11 is formed in a semi-spherical shape.

Therefore, the shock generated when power transmission rod 11 moves to press pedal arm 1 and the front end of power transmission rod 11 contacts with shock-absorbing member 17 is absorbed by shock-absorbing member 17 and the semi-spherical front end of power transmission rod 11 can keep predetermined point contact even through pedal arm 1 is rotating in any way, such that the operational force can be consistently and stably applied to pedal arm 1.

Rod return mechanism 15 includes an inclined surface 19 on the surface of power transmission rod 11 and an inclined groove 21 connected to inclined surface 19, a rod pin 23 that is pressed perpendicular to the longitudinal direction of power transmission rod 11 in contact with inclined surface 19 and inclined groove 21 of power transmission rod 11, and an elastic member 25 that elastically presses rod pin 23 against power transmission rod 11.

That is, the power transmission rod 11 is moved to a predetermined position by a longitudinal component of the force thereof which is applied to inclined surface 19 and inclined groove 21 of power transmission rod 11 by rod pin 23 using the elastic force received from elastic member 25.

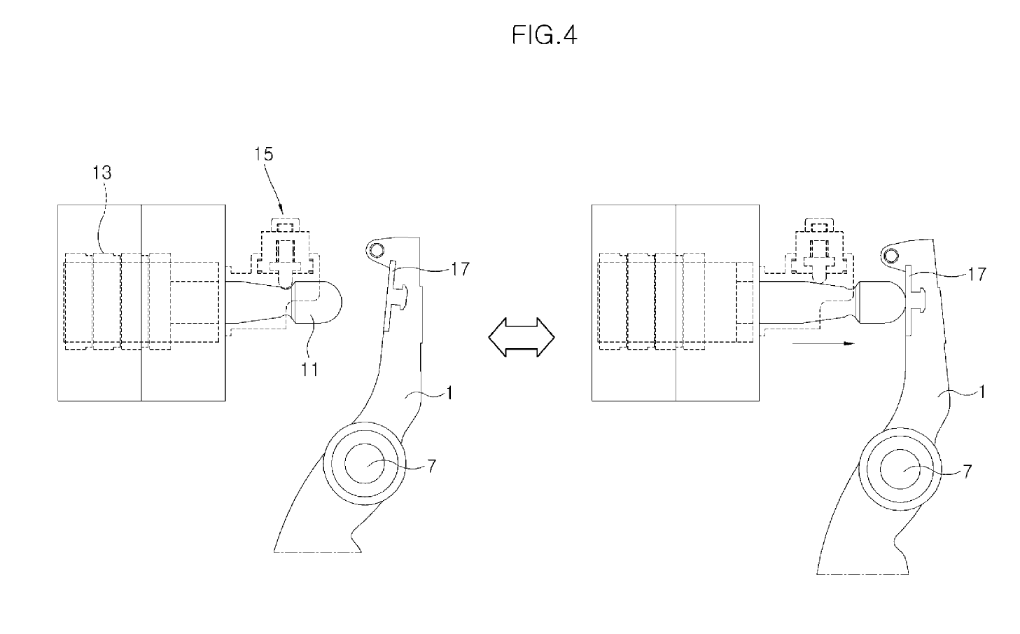

The predetermined position is when rod pin 23 is inserted in inclined groove 21, that is, the state shown at the left in FIG. 4, in which the front end of power transmission rod 11 is spaced apart from pedal arm 1.

Therefore, when the operational force from electromagnetic driver 13 is not applied to power transmission rod 11, power transmission rod 11 automatically moves such that rod pin 23 is inserted in inclined groove 21.

Since power transmission rod 11 is automatically returned by rod return mechanism 15, as described above, even if an one-way solenoid device, which is an example of electromagnetic driver 13, is used, it is possible to make power transmission rod 11 automatically return such that rod pin 23 is inserted in inclined groove 21 by rod return mechanism 15 by cutting the power for the one-way solenoid device after pushing power transmission rod 11 to pedal arm 1.

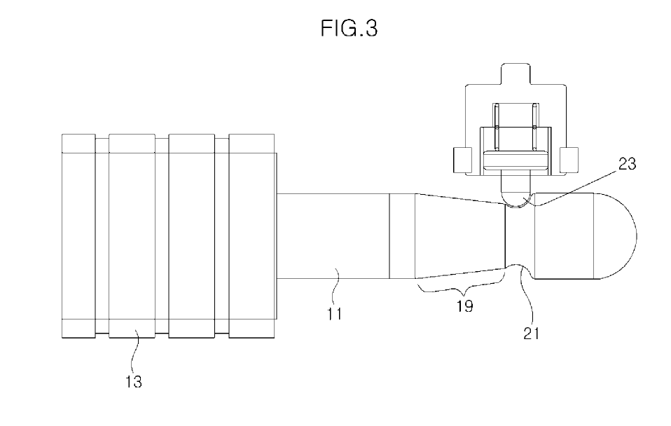

Inclined groove 21 is connected to inclined surface 19 and depressed deeper than inclined surface 19, as shown in FIG. 3, such that power transmission rod 11 is kept in a predetermined state against external vibration when rod pin 23 is inserted in inclined groove 21 and electromagnetic driver 13 does not operate.

In various embodiments, a pin housing 29 with a pin guide 27 that guides rod pin 23 is provided to accommodate rod pin 23 and elastic member 25 and a rod guide 31 that surrounds the outer side of power transmission rod 11 and guides power transmission rod 11 moving straight is integrally and/or monolithically formed with pin housing 29.

Further, pin guide 27 of pin housing 29 has a pin cover 33 to switch opening and closing the inside of pin guide 27 in order to insert rod pin 23 and elastic member 25.

The operation of the present invention having the configuration described above is described hereafter.

First, electromagnetic driver 13 is not operated, when the acceleration pedal for a vehicle according to the present invention operates in a normal state.

Therefore, power transmission rod 11 is kept with rod pin 23 inserted in inclined groove 21 and the front end of power transmission rod 11 is not in contact with pedal arm 1.

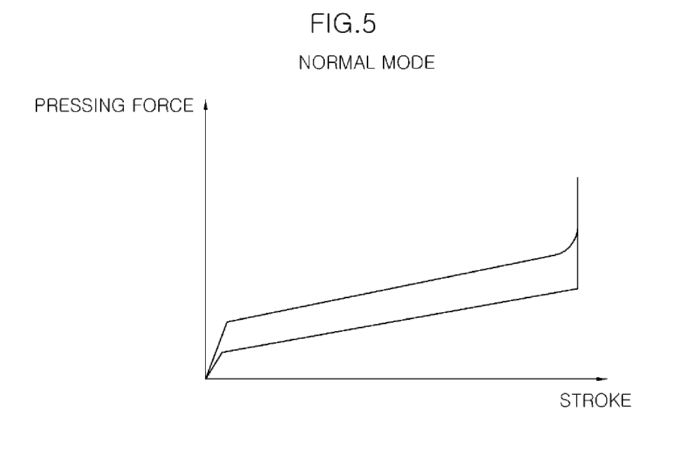

Thereafter, as the driver presses down the pedal, a change in pressing force to rotational stroke of pedal arm 1 shows the characteristics of common acceleration pedals, as shown in FIG. 5.

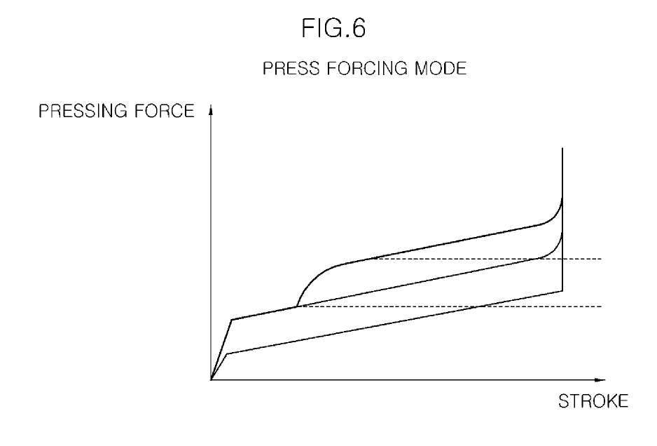

FIG. 6 shows a pressing force mode, in which electromagnetic driver 13 pushes power transmission rod 11 to pedal arm 1, such that pressing force of pedal arm 11 is increased.

That is, when it is required to drive a vehicle in an ECO mode to increase the fuel efficiency of a vehicle, controller 5 operates electromagnetic driver 13 such that the pressing force of pedal arm 1 increases, as shown in FIG. 6, therefore, the driver relatively less presses the pedal, thereby increasing the fuel efficiency of the vehicle.

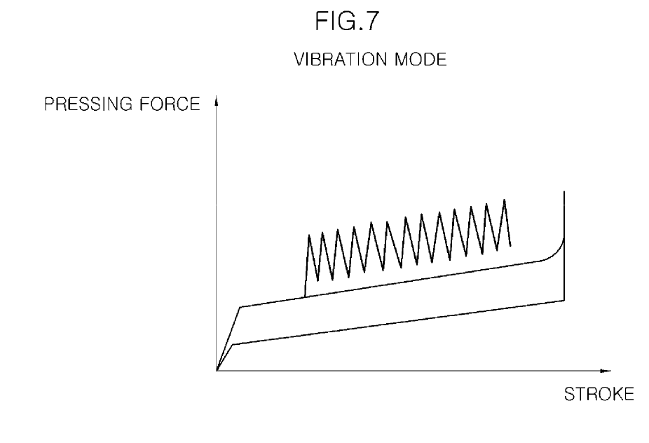

FIG. 7 illustrates a vibration mode, in which when it is sensed by various sensors that the distance from a forward vehicle decreases under a predetermined level, the vehicle travels out of a predetermined lane, or the driver dozes at the wheel, controller 5 operates electromagnetic driver 13 to vibrate pedal arm 1 such that the driver can recognize it.

When electromagnetic driver 13 is a one-way solenoid device, controller 5 repeats supplying and cutting power for the one-way solenoid device, such that power transmission rod 11 repeatedly presses pedal arm 1 by the one-way solenoid device when the power is supplied, and power transmission 11 is repeatedly moved back by rod return mechanism 15 when the power is cut.

Obviously, when electromagnetic driver 13 is a two-way solenoid device, controller 5 operates the two-way solenoid device alternately in two directions, such that the pedal can be vibrated, as described above.

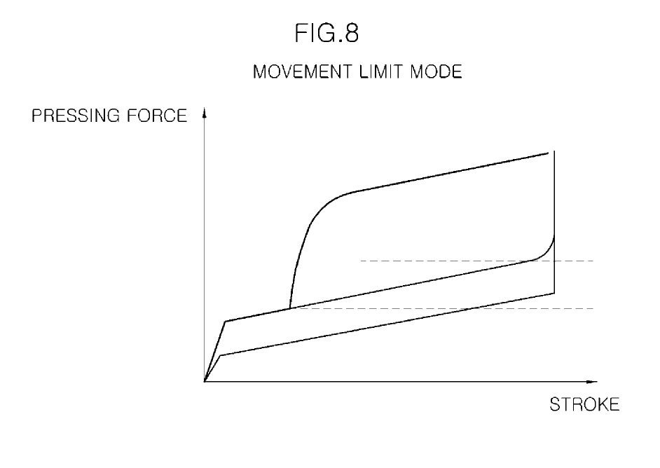

FIG. 8 shows a movement limit mode. This mode can be used for safe traveling of a vehicle, in which when it is determined that the driver excessively presses the acceleration pedal and causes a dangerous situation, controller 5 operates electromagnetic driver 13 such that power transmission rod 11 rapidly increases the pressing force of pedal arm 1, thereby preventing the driver from pressing the pedal with force above a predetermined level and implementing safe traveling of the vehicle.

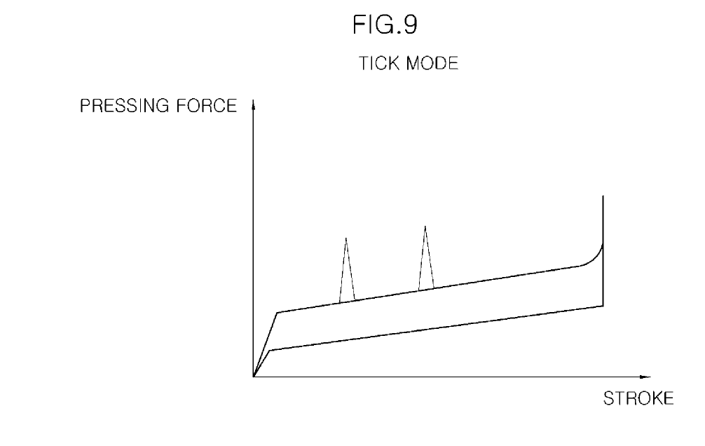

FIG. 9 shows a tick mode, which is used for controller 5 to provide a predetermined signal to a driver. That is, when it is required to send a signal to make a driver shift at a shifting timing of a manual transmission or to make the driver decelerate the vehicle at a specific area by using a locator of the vehicle, controller 5 sends a specific signal to the driver's foot pressing down the peal by instantaneously operating and stopping electromagnetic driver 13 such that the driver can take an appropriate action.

For convenience in explanation and accurate definition in the appended claims, the terms front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An acceleration pedal for a vehicle, comprising:
a pedal arm upon which a pedal is mounted and which is rotatably mounted;
a straight actuator that presses the pedal arm in a return direction by moving straight; and
a controller that controls the straight actuator.

2. The acceleration pedal for a vehicle as defined in claim 1, wherein the straight actuator includes:
a power transmission rod that longitudinally moves straight toward the pedal arm;
an electromagnetic driver that moves straight the power transmission rod; and
a rod return mechanism that returns the power transmission rod to a predetermined position.

3. The acceleration pedal for a vehicle as defined in claim 2, wherein the power transmission rod is spaced apart from the pedal arm when returned by the rod return mechanism;
a shock-absorbing member is disposed at the pedal arm that the front end of power transmission rod contacts; and
the front end of the power transmission rod is formed in a semi-spherical shape.

4. The acceleration pedal for a vehicle as defined in claim 3, wherein the rod return mechanism includes:
an inclined surface on the surface of the power transmission rod and an inclined groove connected to the inclined surface;
a rod pin that is pressed perpendicular to the longitudinal direction of the power transmission rod in contact with the inclined surface and the inclined groove of the power transmission rod; and
an elastic member that elastically presses the rod pin against the power transmission rod.

5. The acceleration pedal for a vehicle as defined in claim 4, further comprising a pin housing that accommodates the rod pin and the elastic member and has a pin guide that guides the rod pin;
wherein a rod guide that surrounds the outer side of the power transmission rod and guides the power transmission rod moving straight is monolithically formed with the pin housing.

6. The acceleration pedal for a vehicle as defined in claim 5, wherein the pin guide of the pin housing has a pin cover to switch opening and closing the inside of the pin guide in order to insert the rod pin and the elastic member.

7. The acceleration pedal for a vehicle as defined in claim 5, wherein the electromagnetic driver is a one-way solenoid device that allows the power transmission rod to move straight only in one direction toward the pedal arm.

8. The acceleration pedal for a vehicle as defined in claim 5, wherein the electromagnetic driver is a two-way solenoid device that allows the power transmission rod to move straight toward and away from the pedal arm.

9. The acceleration pedal for a vehicle as defined in claim 5, wherein the electromagnetic driver is a linear motor.
